(19) United States
(12) Patent Application Publication
(10) Pub. No.: US 2024/0256282 A1
(43) Pub. Date: Aug. 1, 2024

(54) IN-ORDER PROCESSOR USING MULTIPLE-ISSUE SCHEME AND METHOD OF OPERATING THE SAME

(71) Applicant: SAMSUNG ELECTRONICS CO., LTD., SUWON-SI (KR)

(72) Inventors: HYUN-WOO SIM, Suwon-si (KR); HYUNPIL KIM, Suwon-si (KR); SEONGWOO AHN, Suwon-si (KR)

(21) Appl. No.: 18/516,513

(22) Filed: Nov. 21, 2023

(30) Foreign Application Priority Data
Feb. 1, 2023 (KR) 10-2023-0013855

(51) Int. Cl. G06F 9/38; G06F 9/30; G06F 9/32

(52) U.S. Cl. CPC G06F 9/3851; G06F 9/30123; G06F 9/321; G06F 9/3818

(57) ABSTRACT

An in-order processor using a multiple-issue scheme includes a control unit configured to fetch a plurality of instructions together, to determine whether to multiple-issue the plurality of fetched instructions, to decode an issued instruction based on the determination, and to determine whether a stall of the decoded instruction is caused by a data hazard. The processor further includes an execution unit configured to execute an instruction transmitted from the control unit, and a buffer configured to store stall history information on a plurality of multiple-issued instructions when the plurality of multiple-issued instructions are stalled by the data hazard. The control unit determines whether to multiple-issue the plurality of fetched instructions, based on the stall history information of the buffer.

### CROSS-REFERENCE TO RELATED APPLICATION(S)

This application claims priority under 35 U.S.C. § 119 to Korean Patent Application No. 10-2023-0013855, filed on Feb. 1, 2023 in the Korean Intellectual Property Office, the disclosure of which is incorporated by reference herein in its entirety.

### TECHNICAL FIELD

Embodiments of the present disclosure relate to an in-order processor using a multiple-issue method.

### DISCUSSION OF RELATED ART

A stall, which may occur due to a data hazard, may have a great effect on the overall performance of a processor. For example, in terms of an instruction execution order, an effect caused by such a stall may be limited in some high-performance processors adopting an out-of-order scheme, but may be significantly large in in-order processors which have been widely used.

For example, in a processor using a multiple-issue scheme, a large amount of loss may occur in terms of instructions per cycle (IPC) because corresponding slots are stopped when a stall occurs.

### SUMMARY

Example embodiments provide a process which may reduce performance loss caused by data hazard.

In an example embodiment, an in-order processor using a multiple-issue scheme includes a control unit configured to fetch a plurality of instructions together, to determine whether to multiple-issue the plurality of fetched instructions, to decode an issued instruction based on the determination, and to determine whether a stall of the decoded instruction is caused by a data hazard. The processor further includes an execution unit configured to execute an instruction transmitted from the control unit, and a buffer configured to store stall history information on a plurality of multiple-issued instructions when the plurality of multiple-issued instructions are stalled by the data hazard. The control unit determines whether to multiple-issue the plurality of fetched instructions, based on the stall history information of the buffer.

In an example embodiment, a method of operating an in-order processor using a multiple-issue scheme includes fetching a plurality of instructions together in a fetching stage, determining whether to multiple-issue the plurality of fetched instructions in a pre-decoding stage, decoding an issued instruction based on the determination in a decoding stage, where a stall of the decoded instruction is caused by a data hazard, and executing the issued instruction transmitted in the decoded stage in an execution stage. The in-order processor includes a buffer configured to store stall history information on the plurality of multiple-issued instructions when the plurality of multiple-issued instructions are stalled by the data hazard. The pre-decoding stage is a stage of determining whether to multiple-issue the plurality of fetched instructions, based on the stall history information of the buffer.

### BRIEF DESCRIPTION OF DRAWINGS

The above and other features of the present disclosure will be more clearly understood from the following detailed description, taken in conjunction with the accompanying drawings.

FIG. 1 is a diagram illustrating a general structure of an in-order process using a multiple-issue scheme.

FIG. 2 is a block diagram of a processor according to an example embodiment.

FIG. 3 is a diagram illustrating a configuration of a buffer according to an example embodiment.

FIG. 4 is a flowchart illustrating a method of operating a processor according to an example embodiment.

FIG. 5 is a detailed block diagram of a processor according to an example embodiment.

FIG. 6 is a detailed block diagram of a control unit according to an example embodiment.

FIG. 7 is a flowchart illustrating a method of operating a processor according to an example embodiment.

FIG. 8 is a flowchart illustrating a method of operating a processor according to an example embodiment.

FIG. 9 is a diagram illustrating an example of a pipeline executed by a processor according to an example embodiment.

### DETAILED DESCRIPTION

Hereinafter, example embodiments will be described with reference to the accompanying drawings. Like reference numerals may refer to like elements throughout the accompanying drawings.

It will be understood that the terms “first,” “second,” “third,” etc. are used herein to distinguish one element from another, and the elements are not limited by these terms. Thus, a “first” element in an example embodiment may be described as a “second” element in another example embodiment.

It should be understood that descriptions of features or aspects within each example embodiment should typically be considered as available for other similar features or aspects in other example embodiments, unless the context clearly indicates otherwise.

As used herein, the singular forms “a”, “an” and “the” are intended to include the plural forms as well, unless the context clearly indicates otherwise.

Hereinafter, the term “hazard” will refer to a cause of a situation in which a pipeline is suspended, and types thereof include, for example, structural hazard, data hazard, and control hazard. Among the hazards, “data hazard” refers to a case in which execution of the next instruction should be delayed until execution of a previous instruction is completed, due to dependency on results values of instructions. The term “stall” refers to a phenomenon in which a pipeline, executed in a designated cycle, is delayed or stopped because execution of instructions cannot be persistent when hazard occurs. The term “in-order processor” refers to a processor processing given tasks in a predetermined order, and the term “out-of-order process” refers to a processor separating and processing a given task, and then adding the separated tasks to be completed.

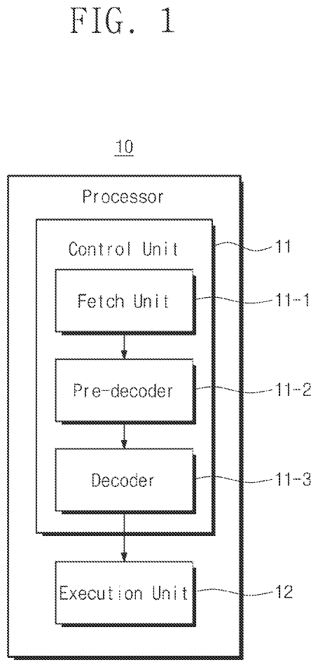

FIG. 1 is a diagram illustrating a general structure of an in-order process using a multiple-issue scheme.

Referring to FIG. 1, a processor 10 may include a control unit 11 (also referred to as a control circuit) and an execution unit 12 (also referred to as an execution circuit). The control unit 11 may include a fetch unit 11-1 (also referred to as a fetch circuit), a pre-decoder 11-2 (also referred to as a pre-decoder circuit), and a decoder 11-3 (also referred to as a decoder circuit). In this case, the fetch unit 11-1, the pre-decoder 11-2, the decoder 11-3, and the execution unit 12 may be hardware components, respectively performing stages of a pipeline including, for example, a fetch stage, a pre-decoding stage, a decoding stage, and an execution stage, executed by the processor 10.

The fetch unit 11-1 may simultaneously fetch a plurality of instructions from a memory. For example, the fetch unit 11-1 may simultaneously fetch two instructions in the case of a dual-issue processor, and may simultaneously fetch three instructions in the case of a triple-issue processor. According to example embodiments, more instructions may be simultaneously fetched.

The pre-decoder 11-2 may perform various processes for multiple issues on a plurality of fetched instructions. For example, the pre-decoder 11-2 may check whether there is dependency between the plurality of fetched instructions, and may determine whether to perform single-issuing to issue only a single instruction or multiple-issuing to issue two or more instructions, among the plurality of fetched instructions, to the decoder 11-3 based on a result of the checking.

As described above, an instruction (in the case of single-issuing) or instructions (in the case of multiple-issuing), issued from the pre-decoder 11-2, may be decoded by the decoder 11-3, and may check occurrence of data hazard with instructions decoded immediately before (for example, instructions currently present in a stage subsequent to the execution stage of the pipeline) to determine whether a stall occurs.

According to a comparative example, the decoder 11-3 checks whether instructions are stalled, after the instructions are issued from the pre-decoder 11-2. Therefore, in a comparative example, even when data hazard is present only in a portion of a plurality of multiple-issued instructions, even remaining instructions having no data hazard are processed as being stalled, resulting in loss.

As a method of preventing such loss, the pre-decoder 11-2 may check whether data hazard with instructions decoded immediately before occurs, in advance. However, a logic for achieving this may serve as a critical path, so that stages of a pipeline should be subdivided. Accordingly, a penalty caused by control hazard may be increased, which may result in an adverse effect.

In various embodiments to be described below, a buffer storing a stall history formed by data hazard may be added and used in a pre-decoding stage to issue remaining instructions, having no data hazard, first. Accordingly, IPC performance may be increased while reducing hardware complexity or critical path.

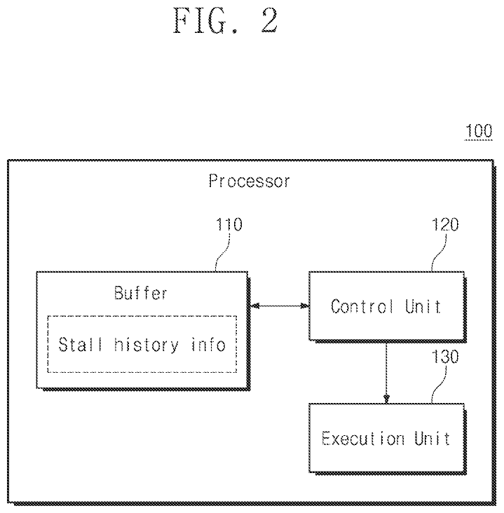

FIG. 2 is a block diagram of a processor 100 according to an example embodiment.

In various embodiments, as an in-order processor using a multiple-issue scheme, the processor 100 may be implemented as various types of processors such as, for example, a central processing unit (CPU), a neural processing unit (NPU), a tensor processing unit (TPU), and a micro processing unit (MPU), an application processor (AP), a graphics processing unit (GPU), a communication processor (CP), an ARM processor, a digital signal processor (DSP), a microprocessor, or the like.

In this case, the processor 100 may be implemented as a system-on-chip (SoC) or a large scale integration (LSI) in which a hardware logic for an operation to be described is embedded, or may be implemented in the form of a field programmable gate array (FPGA). However, example embodiments are not limited thereto.

According to example embodiments, the processor 100 may execute computer-executable instructions stored in a memory to perform various functions.

Referring to FIG. 2, the processor 100 may include a buffer 110 (also referred to as a buffer circuit), a control unit 120 (also referred to as a control circuit), and an execution unit 130 (also referred to as an execution circuit). FIG. 2 illustrates a brief example of a configuration of the processor 100 in association with an example embodiment. Accordingly, components that are not illustrated in FIG. 2 for performing operations associated with example embodiments may be further included in the processor 100.

The control unit 120 may be configured to fetch an instruction from a memory to decode the fetched instruction, and to control an execution flow of an instruction on the pipeline.

For example, the processor 100 uses a multiple-issue scheme in various embodiments, so that the control unit 120 may be configured to fetch a plurality of instructions together, to determine whether to multiple-issue the plurality of fetched instructions, to decode the issued instruction based on the determination, and to determine whether the decoded instruction is stalled due to data hazard. According to example embodiments, when a plurality of instructions are referred to as being multiple-issued, more than one of the plurality of instructions may be issued.

The execution unit 130 may execute instructions transmitted from the control unit 120. To this end, the execution unit 130 may include, for example, an arithmetic logic unit (ALU), a floating-point unit (FPU), a multiplier, or the like. However, example embodiments are not limited thereto.

When a plurality of multiple-issued instructions are stalled due to data hazard, the buffer 110 may store stall history information on the plurality of stalled instructions. In this case, the stall history information may include tag information of the plurality of stalled instructions and hazard information on an instruction causing the stall. The buffer 110 may be implemented as, for example, a flip-flop, a static random access memory (SRAM), or the like, according to embodiments. However, example embodiments are not limited thereto.

For example, according to an example embodiment, the control unit 120 may use the stall history information stored in the buffer 110 when the processor 100 determines whether to multiple-issue the plurality of fetched instructions.

For example, when two dual-issued instructions are stalled due to data hazard, stall history information on the stalled two instructions may be stored in the buffer 110. In such a state, when the two instructions are re-fetched together, the control unit 120 may single-issue an instruction, which does not cause a stall, of the two instructions. According to embodiments, when an instruction among a plurality of instructions is referred to as being single-issued, only the one instruction among the plurality of instructions may be issued.

For example, the stall history information includes the tag information of the two stalled instructions and the hazard information on the instruction, causing a stall, of the two instructions, so that the control unit 120 may identify the instruction, which does not cause the stall, of the two fetched instructions, and may single-issue the identified instruction.

As described above, according to an example embodiment, the processor 100 may store the stall history information in the buffer 110 and may discern possibility of hazard stall for the plurality of fetched instructions using the stored stall history information in advance. Accordingly, an executable instruction may be additionally issued first without a stall, and as a result, IPC performance may be increased.

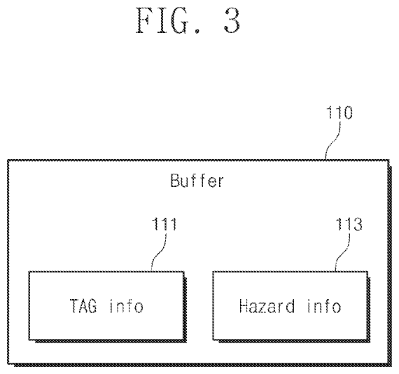

FIG. 3 is a diagram illustrating a configuration of the buffer 110 according to an example embodiment. Referring to FIG. 3, stall history information including tag information 111 and hazard information 113 may be stored in the buffer 110.

The tag information 111 may be information allowing a plurality of stalled instructions (or instruction sets) to be identified. In this case, according to an example embodiment, the tag information 111 may include a program counter (PC) value and a first instruction among the plurality of stalled instructions.

For example, when two instructions are multiple-issued and then stalled due to data hazard in a dual-issue processor, a PC value of a first instruction of the two stalled instructions may be stored in the tag information 111 representing the two stalled instructions. The first instruction refers to an instruction, having a relatively preceding PC value, of the two instructions.

The hazard information 113 may include identification information indicating which instruction, among the plurality of stalled instruction, caused a stall, for example, identification information indicating an instruction causing a stall (or an instruction which did not cause a stall), and may match corresponding tag information 111 to be stored in the buffer 110.

According to an example embodiment, among the plurality of stalled instructions, an instruction causing a stall may be represented as “1,” and an instruction which does not cause the stall may be represented as “0.” Accordingly, for example, when a stall is caused by a first instruction of two stalled instructions, identification information may be “10.” When a stall is caused by a second instruction of the two stalled instructions, identification information may be “01.” In addition, when a stall is caused by the both stalled instructions, identification information may be “11.” However, example embodiments are not limited thereto.

According to an example embodiment, a portion of a PC value of an instruction may be used as a tag address. For example, 16 pieces of stall history information are used in a 32-bit processor, lower 4 bits (for example, a 27th bit to a 30th bit) except for the least significant 2 bits of a 32-bit PC value may be used a tag address (in this case, tag information may be information of a first bit to a 26th bit of the PC value).

Accordingly, the control unit 120 may read tag information from a position of the buffer 110 corresponding to a PC value of the first instruction, among the plurality of fetched instructions, and may determine whether to multiple-issue the plurality of fetched instructions, based on whether the read tag information matches the PC value of the first instruction.

As a further detailed example, the control unit 120 may read tag information from a position of the buffer 110 corresponding to a tag address included in a PC value of the first instruction, among the plurality of fetched instructions, and may check whether the read tag information matches a portion corresponding to tag information in the PC value of the first instruction (in the above example, a remaining portion except for the lower 6 bits) to determine whether to multiple-issue the plurality of fetched instructions.

According to example embodiments, hazard information may further include branch information, indicating whether a branch instruction is taken or is not taken, when a previous instruction, associated with an instruction causing a stall, is the branch instruction. As described above, the branch information is further utilized because an instruction causing a stall may vary depending on whether the branch instruction is taken or is not taken.

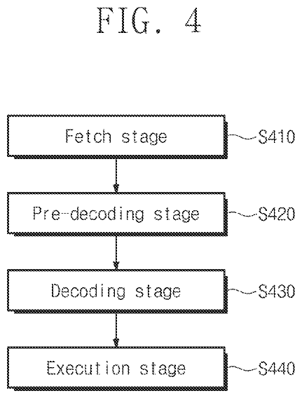

FIG. 4 is a flowchart illustrating a method of operating a processor according to an example embodiment. Each stage illustrated in FIG. 4 may correspond to the pipeline structure of the processor 100. In some embodiments, other stages that are not illustrated may be further added.

In various embodiments, the processor 100 may be an in-order processor using a multiple-issue scheme. Accordingly, referring to FIG. 4, in the fetch stage S410, the processor 100 may fetch a plurality of instructions together.

In the pre-decoding stage S420, the processor 100 may determine whether to multiple-issue the plurality of fetched instructions, and may issue an instruction based on the determination.

In the decoding stage S430, the processor 100 may decode the issued instruction and may determine whether the decoded instruction is stalled due to data hazard.

In the execution stage S440, the processor 100 may execute the instruction transmitted through the decoding stage S430.

For example, the processor 100 may include the buffer 110 that stores stall history information. The stall history information may be information on a plurality of multiple-issued instructions when the plurality of multiple-issued instructions are stalled due to a data hazard, and may include tag information of the plurality of stalled instructions and hazard information on an instruction causing the stall.

Accordingly, in an example embodiment, in the pre-decoding stage S420, the processor 100 may determine whether to multiple-issue the plurality of fetched instructions, using the stall history information of the buffer 110.

For example, the tag information may include a program counter (PC) value of a first instruction, among a plurality of stalled instructions, and the hazard information may include identification information indicating which instruction, among the plurality of stalled instructions, caused the stall.

The tag information may be stored in the buffer 110 using a portion of the PC value of the first instruction, among the plurality of stalled instructions, and identification information may be matched with the tag information and stored in the buffer 110.

Accordingly, in the pre-decoding stage S420, the processor 100 may determine whether to multiple-issue the plurality of fetched instructions, based on whether tag information, read from a position of the buffer 110 corresponding to the PC value of the first instruction, among the plurality of fetched instructions, matches the PC value of the first value, among the plurality of fetched instructions.

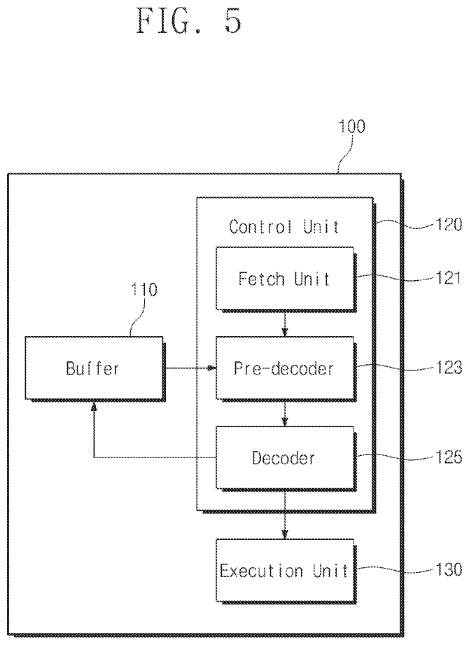

FIG. 5 is a detailed block diagram of a processor according to an example embodiment. Referring to FIG. 5, for convenience of explanation, a further description of components and technical aspects previously described may be omitted, and differences from those described above will be mainly described.

Referring to FIG. 5, the processor 100 may include the buffer 110, the control unit 120, and the execution unit 130. In this case, the control unit 120 may include a fetch unit 121, a pre-decoder 123, and a decoder 125. The fetch unit 121, the pre-decoder 123, and the decoder 125 may be hardware logics, respectively performing a fetch stage, a pre-decode stage, and a decoding stage in a pipeline executed by the processor 100.

For example, the fetch unit 121 may read an instruction to be executed next from a memory based on a PC value of a PC register. In this case, the processor 100 uses a multiple-issue scheme in example embodiments, so that the fetch unit 121 may fetch a plurality of instructions together.

For example, when a dual-issue scheme is applied, two instructions may be simultaneously fetched by the fetch unit 121, and when a triple-issue scheme is applied, three instructions may be simultaneously fetched by the fetch unit 121. According to example embodiments, more instructions may be fetched together by the fetch unit 121.

The pre-decoder 123 may determine whether to multiple-issue the plurality of fetched instructions, and may issue an instruction to the decoder 125 based on the determination. For example, in the case of a processor using a multiple-issue method, a plurality of instructions are fetched together, so that data hazard may be present between the plurality of fetched instructions. Accordingly, the pre-decoder 123 may determine dependency between a plurality of fetched instructions, and may determine whether to multiple-issue the plurality of fetched instructions based on the determined dependency.

For example, in the case of a dual-issue processor, the pre-decoder 123 determines whether there is dependency between two instructions fetched together from the fetch unit 121. When it is determined that there is dependency, the pre-decoder 123 may single-issue only a first instruction having a preceding PC value to the decoder 125. Alternatively, when it is determined that there is no dependency, the pre-decoder 123 may multiple-issue the two fetched instructions to the decoder 125.

The decoder 125 may decode the instruction issued by the pre-decoder 123, and may determine whether the decoded instruction is stalled due to data hazard.

For example, when a plurality of instructions are multiple-issued by the pre-decoder 123, the decoder 125 may decode the multiple-issued instructions and may determine whether the plurality of multiple-issued instructions are stalled due to data hazard, based on whether there is dependency between the plurality of decoded instructions and previous instructions. The previous instructions may include instructions present in an execution stage and subsequent stages of a pipeline executed by the processor 100. When there is dependency between currently decoded instructions and previous instructions, the plurality of currently decoded instructions may be stalled in a stage of the decoder 125.

As described above, when the plurality of multiple-issued instructions are stalled, the decoder 125 may update stall history information of the buffer 110 using identification information on a PC value of a first instruction, among the plurality of stalled instructions, and an instruction causing the stall.

For example, when two instructions are multiple-issued by the dual-issue processor and there is dependency between a first instruction of the two instructions and previous instructions, the multiple-issued two instructions may be stalled together in the stage of the decoder 125. In this case, the decoder 125 may update tag information 111 and hazard information 113 of the buffer 110 using identification information (“10” in an example of FIG. 3) indicating a PC value of the first instruction and an instruction causing the stall.

On the other hand, when there is dependency between a second instruction of the two instructions and previous instructions, the two instructions may also be stalled together in the stage of the decoder 125. In this case, the decoder 125 may update the tag information 111 and the hazard information 113 of the buffer 110 using identification information (“01” in an example of FIG. 3) indicating a PC value of the first instruction and an instruction causing the stall.

In this case, a portion of the PC value of the first instruction may be used as an address of the buffer 110 by which the tag information 111 and the hazard information 113 are updated, as set forth above.

It will be appreciated that even when a single instruction is single-issued by the pre-decoder 123, the decoder 125 may decode the single-issued instruction to check whether a data hazard with previous instructions occurs and may determine whether a currently decoded instruction is stalled, based on a result of the checking.

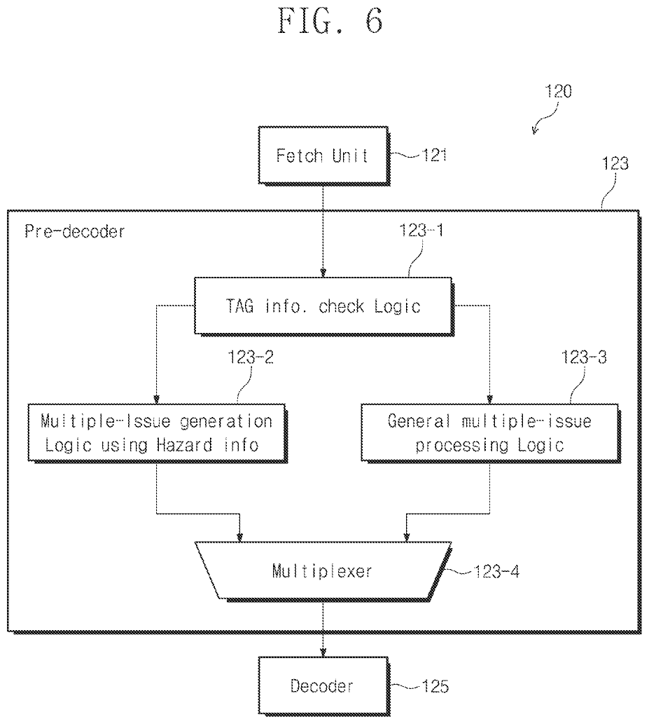

Hereinafter, various embodiments in which stall history information stored (or updated) in the buffer 110 will be described with reference to FIG. 6. Referring to FIG. 6, for convenience of explanation, a further description of components and technical aspects previously described may be omitted, and differences from those described above will be mainly described.

FIG. 6 is a detailed block diagram of a control unit according to an example embodiment. Referring to FIG. 6, the pre-decoder 123 may include a tag information check logic 123-1, a multiple-issue generation logic 123-2 using hazard information, a general multiple-issue processing logic 123-3, and a multiplexer 123-4.

The tag information check logic 123-1 may check whether tag information 111 corresponding to a plurality of instructions, transmitted from the fetch unit 121, is present in the buffer 110. For example, the tag information check logic 123-1 may read tag information 111 of the buffer 111 based on a PC value (e.g., a portion of the PC value, used as a tag address) of a first structure of the plurality of instructions transmitted from the fetch unit 121, and may check whether the tag information 111 of the buffer 110 matches a PC value (e.g., a portion of the PC value, corresponding to tag information) of the first instruction, to check whether the tag information corresponding to the plurality of instructions are present in the buffer 110.

When the tag information 111 corresponding to the plurality of instructions is checked and is determined to not be present in the buffer 110, for example, when the tag information read from the buffer 110 does not match the PC value of the first instruction, a general multiple-issue processing operation may be performed by the general multiple-issue processing logic 123-3. In this case, the general multiple-issue processing logic 123-3 may check whether there is dependency between the plurality of instructions and may determine whether to multiple-issue the plurality of instructions, based on a result of the checking. For example, the general multiple-issue processing logic 123-3 may multiple-issue the plurality of instructions when there is no dependency between the plurality of instructions and may single-issue the first instruction when there is a dependency therebetween. However, example embodiments are not limited thereto.

When the tag information 111 corresponding to the plurality of instructions is checked and is determined to be present in the buffer 110, for example, when the tag information read from the buffer 110 matches the PC value of the first instruction, the multiple-issue generation logic 123-2 using hazard information may determine whether to multiple-issue the plurality of instruction, based on hazard information stored in the buffer 110 (e.g., hazard information matched with the read tag information and stored).

Matching the tag information read from the buffer 110 with the PC value of the first instruction means that a plurality of instructions, such as a plurality of instructions having a history of being stalled, were re-fetched. Therefore, an in-order processor may determine whether to multiple-issue the plurality of instructions, based on hazard information, and thus may separately issue an instruction executable first without occurrence of a stall, which may result in increased IPC performance.

Instruction(s), issued by the general multiple-issue processing logic 123-3 or the multiple-issue generation logic 123-2 using hazard information, may be transmitted to the decoder 125 through the multiplexer 123-4.

Hereinafter, various embodiments which may be performed by the multiple-issue generation logic 123-2 using hazard information will be described through an example to which a dual-issue scheme is applied.

When the tag information 111 corresponding to two instructions transmitted from the fetch unit 121 are checked and determined to be present in the buffer 110, the multiple-issue generation logic 123-2 using the hazard information may determine whether a stall is caused by first information of the two instructions, based on the hazard information stored in the buffer 110.

When the stall is not determined to be caused by the first instruction, the multiple-issue generation logic 123-2 using the hazard information may single-issue the first instruction of the two instructions to the decoder 125.

When the stall is determined to be caused by the first instruction, the multiple-issue generation logic 123-2 using the hazard information may check to determine whether there is dependency between two instructions. In this case, the multiple-issue generation logic 123-2 may check to determine whether there is dependency between the two instruction in the case in which a first instruction of the two instructions is issued first, as well as in the case in which a second instruction of the two instructions is issued first. Accordingly, when dependency is checked and determined to not be present in both of the cases, the multiple-issue generation logic 123-2 using the hazard information may single-issue the second instruction of the two instructions.

As described above, according to various embodiments, an instruction which does not cause a stall, among a plurality of instructions, may be single-issued from the pre-decoder 123 to the decoder 125. As a result, IPC performance of the processor 100 may be increased.

When a result of the checking is a determination that there is dependency between the two instructions, the multiple-issue generation logic 123-2 may perform a general issue operation using hazard information according to an example embodiment. When a stall is caused by a first instruction of the two instructions and there is dependency between the two instructions, the stall may occur even if any one of the two instructions is single-issued. Accordingly, the multiple-issue generation logic 123-2 using the hazard information may single-issue the first instruction, similarly to the operation of the above-described general multiple-issue processing logic 123-3. However, the general issue operation is not limited thereto.

When the result of the checking is that there is dependency between the two instructions, the multiple-issue generation logic 123-2 using the hazard information may issue another subsequent instruction in advance through additional checking of dependency according to an example embodiment. For example, when the result of the checking is that there is dependency between the two instructions, the multiple-issue generation logic 123-2 using the hazard information may additionally check whether there is dependency between the two instructions, checked to have the dependency, and the next instruction. When a result of the additional checking is that there is not dependency therebetween, the multiple-issue generation logic 123-2 may single-issue the next instruction first.

As described above, when the stall is determined to be caused by the first instruction, the multiple-issue generation logic 123-2 using the hazard information may check dependency between the two instructions and may operate based on a result of the checking. However, example embodiments are not limited thereto.

For example, according to example embodiments, when a stall is not determined to be caused by the first instruction, the first instruction which did not cause the stall may be single-issued. When a stall is determined to be caused by the first instruction, a determination may be made as to whether the general multiple-issue processing logic 123-3 performs a multiple-issue operation. Since the first instruction which does not cause the stall may be single-issued even in the above operation, a certain level of performance may be secured. In addition, since a logic checking whether there is dependency between the two instructions is not implemented, hardware complexity may be reduced.

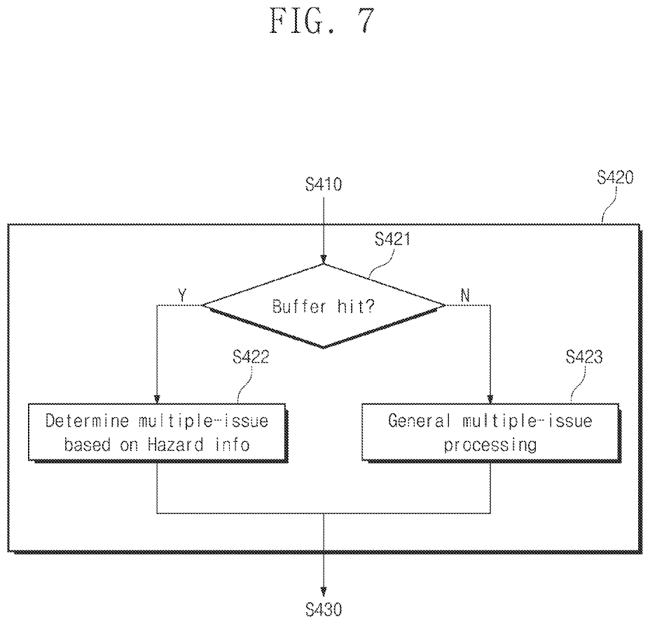

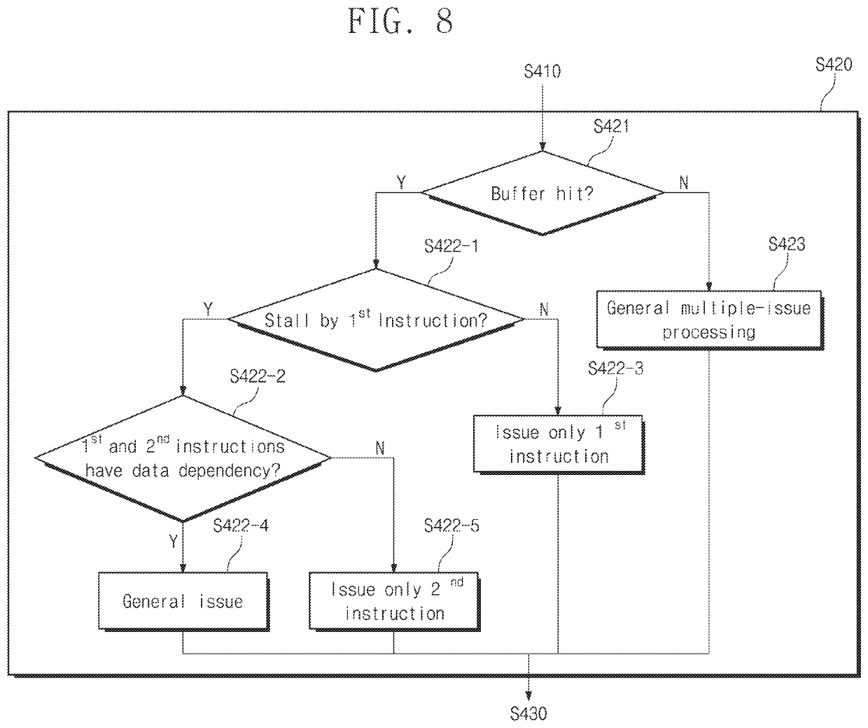

Hereinafter, the operation of the processor 100 in the pre-decoding stage S420 of FIG. 4 will be described in more detail with reference to FIGS. 7 and 8.

FIG. 7 is a flowchart illustrating a method of operating a processor according to an example embodiment. Referring to FIG. 7, in a fetch stage S410, the processor 100 may fetch a plurality of instructions (e.g., multiple-issue candidate instructions).

In the pre-decoding stage S420, the processor 100 may check to determine whether tag information 111 corresponding to the plurality of fetched instructions are present in the buffer 110 (S421). That is, in operation S421, it may be determined whether a buffer hit occurs. For example, the processor 100 may read the tag information of the buffer 110 based on a PC value of a first instruction, among a plurality of instructions transmitted from the fetch unit 121, and may check whether the read tag information and the PC value of the first instruction match each other, and thus, may check to determine whether the tag information 111 corresponding to the plurality of instructions are present in the buffer 110. For example, the processor 100 may read tag information of the buffer 110 based on a portion, used as a tag address, of the PC value of the first instruction, and may compare the read tag information with a portion, corresponding to the tag information, of the PC value of the first instruction to check to determine whether the tag information and the portion corresponding to the tag information match each other. When the tag information and the portion corresponding to the tag information match each other, the processor 100 may determine that the tag information corresponding to the plurality of fetched instructions are present in the buffer 110.

When a result of the checking is that the tag information 111 corresponding to the plurality of instructions are not present in the buffer 110, for example, when the tag information read from the buffer 110 and the PC value of the first instruction do not match each other (S421, No), the processor 100 may perform a general multiple-issue processing operation (S423). In the multiple-issue processing operation S423, the processor 100 may check to determine whether there is dependency between the plurality of fetched instructions and may determine whether to multiple-issue the plurality of instructions, based on a result of the checking. For example, the processor 100 may multiple-issue the plurality of instructions when there is no dependency between the plurality of instructions and may single-issue a first instruction when there is dependency between the plurality of instructions. However, example embodiments are not limited thereto.

When the tag information 111 corresponding to the plurality of instruction is present in the buffer 110, for example, when the tag information read from the buffer 110 and the PC value of the first instruction match each other (S421, Yes), the processor 100 may determine whether to multiple-issue the plurality of instructions, based on hazard information stored in the buffer 110 (S422).

Accordingly, according to an example embodiment, a determination may be made as to whether a plurality of currently fetched instructions have a history of being stalled, based on the tag information 111 of the buffer 110. When the plurality of currently fetched instructions do not have a history of being stalled, an instruction executable without occurrence of a stall may be identified based on the hazard information 113 matched with the tag information 111 and stored. Therefore, among the plurality of fetched instructions, the instruction executable without occurrence of the stall may be separately issued first. As a result, IPC performance of the processor 100 may be increased.

FIG. 8 is a flowchart illustrating a detailed method of operating the processor 100 according to an example embodiment in the pre-decoding stage S420. Referring to FIG. 8, for convenience of explanation, a further description of components and technical aspects previously described may be omitted, and differences from those described above with reference to FIG. 7 will be mainly described. In addition, in FIG. 8, for convenience of explanation, a description will be provided with respect to a case of a processor 100 to which a dual-issue scheme is applied.

Referring to FIG. 8, when the tag information 111 corresponding to the two instructions is present in the buffer 110, for example, when the tag information read from the buffer 110 and the PC value of the first instruction match each other (S421, Yes), the processor 100 may determine whether a stall is caused by a first instruction of two stalled instructions, based on the hazard information matched with the tag information 111 and stored (S422-1).

When a result of the determination is that a stall is not caused by the first instruction (S422-1, No), the processor 100 may single-issue the first instruction of the two instructions to the decoding stage S430 (S422-3).

When a result of the determination is that a stall is caused by the first instruction (S422-1, Yes), the processor 100 may check to determine whether there is dependency between the two instructions (S422-2). According to an example embodiment, not only a case in which the first instruction of the two instructions is executed first, but also a case in which a second instruction of the two instructions is executed first, the processor 100 may check to determine whether there is dependency between the two instructions. Accordingly, when a result of the checking is that there is no dependency in both of the cases (S422-2, No), the processor 100 may single-issue the second instruction of the two instructions (S422-5).

As described above, according to various embodiments, among a plurality of instructions, an instruction which does not cause a stall may be identified in advance to be single-issued from the pre-decoding state 420 to the decoding stage S430, and as a result, IPC performance of the processor 100 may be increased.

When a result of the checking is that there is dependency between the two instructions (S422-2, Yes), a general issue operation may be performed (S422-4). In this case, a stall may occur even when any instruction of the two instructions is single-issued. Therefore, according to an example embodiment, the processor 100 may single-issue the first instruction, similarly to the result of general multiple-issue processing operation (S423) described above with reference to FIG. 7. However, example embodiments are not limited to the embodiment illustrated in FIG. 8. For example, when a result of the checking is that there is dependency between the two instructions (S422-2, Yes), the processor 100 may issue the next instruction in advance through additional checking of dependency, as described above with reference to FIG. 6.

FIG. 8 illustrates an example embodiment in which when a stall is identified to be caused by the first instruction (S422-1, Yes), the processor 100 may check to determine whether there is dependency between the two instruction and operate based on a result of the checking. However, example embodiments are not limited thereto.

For example, according to example embodiments, when a stall is not identified to be caused by the first instruction (S422-1, No), a first instruction which does not cause the stall may be single-issued (S422-3). Alternatively, when a stall is identified to be caused by the first instruction (S422-1, Yes), general multiple-issue processing operation S423 may be performed. Since the first instruction which does not cause the stall may be single-issued even in such operations, a certain level of performance may be secured. In addition, since a logic checking to determine whether there is dependency between the two instruction is not implemented, hardware complexity may be reduced.

According to an example embodiment, stall history information may be stored or updated in the decoding stage S430. For example, in the decoding stage S430, when a plurality of multiple-issued instruction are decoded, the processor 100 may determine whether a stall occurs due to data hazard, based on whether there is dependency between the plurality of decoded instructions and previous instructions which are being executed in the execution stage S440. Accordingly, when a stall of the plurality of multiple-issued instructions are caused by at least one of a plurality of instructions, the processor 100 may update the stall history information of the buffer 110 using a PC value of a first instruction, among the plurality of instructions, and identification information of an instruction causing a stall. As described above, the updated stall history information may be used in the above-described embodiments.

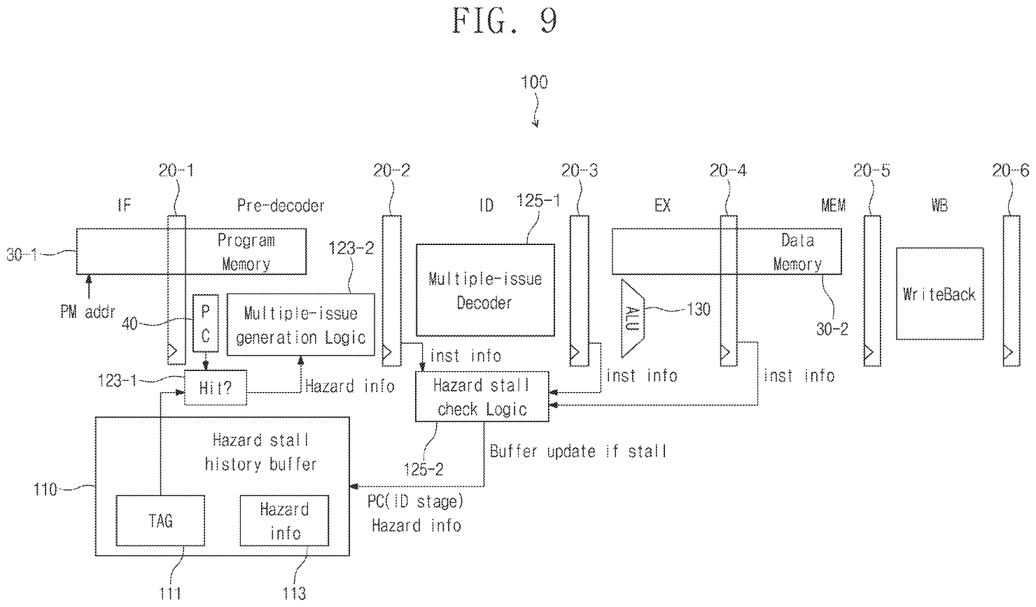

FIG. 9 is a diagram illustrating an example of a pipeline executed by the processor 100 according to an example embodiment. In FIG. 9, reference numerals 20-1, 20-2, 20-3, 20-4 and 20-6 denote registers associated with each stage of the pipeline, a reference numeral 30-1 denotes a program memory in which instructions are stored, a reference numeral 30-2 denotes a data memory, and a reference numeral 40 denotes an address of a memory in which an instruction to be executed next is stored, for example, a register having a PC value. For convenience of explanation, a further description of components and technical aspects previously described may be omitted, and redundant descriptions of components using the same reference numerals as those used previously will be omitted.

An operation of updating the buffer 110 and a hazard stall check logic using the buffer 110 will be described with reference to FIG. 9. Hereinafter, the operation of updating the stall history information in the buffer 110 will be described.

Referring to FIG. 9, in an instruction fetch (IF) stage, the fetch unit 121 may fetch a plurality of instructions from the program memory 30-1 based on a calculated program memory address PM addr. In the pre-decoder stage, when a multiple-issue instruction is generated by a multiple-issue generation logic 123-2, the generated multiple-issue instruction may be transmitted to an instruction decode (ID) stage and may be decoded by a multiple-issue decoder 125-1. In FIG. 9, ID refers to an instruction decode stage, EX/MEM refer to an executed/memory stage, and WB refers to a writeback stage.

In this case, in an ID stage, a hazard stall check logic 125-2 may determine whether an instruction of a current ID stage is to utilize a stall caused by a data hazard, based on instruction information inst info transmitted to the ID stage and the previous instruction information inst info already transmitted to an executed/memory (EX/MEM) stage. When the instruction of the current ID stage is determined to implement the stall caused by the data hazard, a stall may immediately occur in the ID stage.

When a stall occurs, the hazard stall check logic 125-2 may update TAG 111 and hazard information 113 of the hazard stall history buffer 110 using program counter (PC) information of an instruction stalled in the ID stage and hazard information (for example, information on which instruction causes a stall).

Hereinafter, the hazard stall check logic using the buffer 110 will be described.

A tag information check logic 123-1 may read TAG 111 from a position of the hazard stall history buffer 110 corresponding to a PC value of a first instruction, among multiple-issue candidate instructions fetched together, and may compare the read TAG 111 with the PC value of the first instruction. When the TAG 111 and the PC value of the first instruction match each other, the tag information check logic 123-1 may determine that an instruction packet corresponding to a current address causes a hazard stall.

Accordingly, the tag information check logic 123-1 may transmit information on whether the hazard stall occurs and the hazard information to the multiple-issue generation logic 123-2. When a stall occurs, the multiple-issue generation logic 123-2 may transmit only an instruction packet, which does not cause a stall, to the ID stage depending on conditions, as described above with reference to FIG. 8.

According to example embodiments, when a PC reference point of the TAG 111 stored in the hazard stall history buffer 110 is based on a preceding instruction (for example, an instruction already transmitted to the execute/memory (EX/MEM) stage), TAG comparison may be performed in advance. In this case, the TAG 111 should be updated based on a PC value of the preceding instruction even when the hazard stall history buffer is updated.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions.

For convenience of explanation, a description has been mainly provided of an example of a processor adopting a dual-issue scheme. However, example embodiments are not limited thereto, and it will be appreciated that the above-described embodiments may be applied to an in-order processor in which three or more instructions are fetched together and executed by adopting a triple-issue scheme, a quadruple-issue scheme, or the like.

According to the above-described embodiments, possibility of occurrence of a hazard stall may be discerned in advance in a stage prior to a decoding stage. Accordingly, among a plurality of fetched instructions, an instruction executable without occurrence of a stall may be separately issued and executed in advance. As a result, in an in-order processor adopting a multiple-issue scheme, IPC performance may be increased while reducing hardware complexity or a critical path.

As described above, according to example embodiments, performance loss of a process, caused by data hazard, may be reduced using a buffer storing stall history information.

While example embodiments have been shown and described above, it will be apparent to those skilled in the art that modifications and variations could be made without departing from the scope of the present disclosure as defined by the following claims.

What is claimed is:

1. A processor using a multiple-issue scheme, comprising:
a control unit configured to fetch a plurality of instructions together, to determine whether to multiple-issue the plurality of fetched instructions, to decode an issued instruction based on the determination, and to determine whether a stall of the decoded instruction is caused by a data hazard;
an execution unit configured to execute an instruction transmitted from the control unit; and
a buffer configured to store stall history information on a plurality of multiple-issued instructions when the plurality of multiple-issued instructions are stalled by the data hazard,
wherein the control unit determines whether to multiple-issue the plurality of fetched instructions, based on the stall history information of the buffer.

2. The processor of claim 1, wherein
the stall history information comprises tag information of the plurality of stalled multiple-issued instructions and hazard information on an instruction causing the stall.

3. The processor of claim 2, wherein
the tag information comprises a program counter (PC) value of a first instruction, among the plurality of stalled multiple-issued instructions, and
the hazard information comprises identification information on which instruction, among the plurality of stalled multiple-issued instructions, causes the stall.

4. The processor of claim 3, wherein
the tag information is stored in the buffer using a portion of the PC value of the first instruction, among the plurality of stalled multiple-issued instructions,
the hazard information is matched with the tag information and stored in the buffer, and
the control unit determines whether to multiple-issue the plurality of fetched instructions, based on whether the tag information read from a position of the buffer corresponding to the PC value of a first instruction, among the plurality of fetched instructions, matches the PC value of the first instruction, among the plurality of fetched instructions.

5. The processor of claim 4, wherein the control unit is further configured to:
determine whether to multiple-issue the plurality of fetched instructions, based on whether there is a dependency between the plurality of fetched instructions, when the read tag information does not match the PC value of the first instruction, among the plurality of fetched instructions; and
determine whether to multiple-issue the plurality of fetched instructions, based on the hazard information, when the read tag information matches the PC value of the first instruction, among the plurality of fetched instructions.

6. The processor of claim 5, wherein
the control unit is further configured to single-issue the first instruction, among the plurality of fetched instructions, when the stall is not identified to be caused by the first instruction, among the plurality of stalled multiple-issued instructions, based on the hazard information.

7. The processor of claim 5, wherein
the processor is an in-order processor using a dual-issue scheme, and
the control unit is further configured to fetch two instructions together, to determine whether there is a dependency between the two fetched instructions when the stall is identified to be caused by the first instruction, among the plurality of stalled multiple-issued instructions, based on the hazard information, and to single-issue a second instruction of the two fetched instructions when a result of the determining is that there is no dependency between the two fetched instructions.

8. The processor of claim 7, wherein
the control unit is further configured to single-issue the second instruction when the dependency is not determined to be present both in a case in which the first instruction of the two instructions is executed first, and in a case in which the second instruction of the two instructions is executed first.

9. The processor of claim 1, wherein the control unit comprises:
a fetch unit configured to fetch the plurality of instructions together;
a pre-decoder configured to determine whether to multiple-issue the plurality of fetched instructions; and
a decoder configured to decode the issued instruction, which is issued by the pre-decoder, and to determine whether the stall of the decoded instruction is caused by the data hazard,
the decoder updates the stall history information in the buffer when the plurality of multiple-issued instructions are stalled, and
the pre-decoder determines whether to multiple-issue the plurality of fetched instructions, based on the stall history information of the buffer.

10. The processor of claim 9, wherein the decoder is further configured to:
determine whether the stall is caused by the data hazard, based on whether there is a dependency between the plurality of multiple-issued instructions and previous instructions which are being executed by the execution unit, when the plurality of multiple-issued instructions are decoded; and
update the stall history information of the buffer using a program counter (PC) value of a first instruction, among the plurality of instructions, and identification information of an instruction causing the stall when the plurality of multiple-issued instructions are stalled by at least one of the plurality of instructions.

11. A method of operating a processor using a multiple-issue scheme, the method comprising:
fetching a plurality of instructions together in a fetching stage;
determining whether to multiple-issue the plurality of fetched instructions in a pre-decoding stage;
decoding an issued instruction based on the determination in a decoding stage, wherein
a stall of the decoded instruction is caused by a data hazard; and
executing the issued instruction transmitted in the decoded stage in an execution stage,
wherein
the processor comprises:
a buffer configured to store stall history information on the plurality of multiple-issued instructions when the plurality of multiple-issued instructions are stalled by the data hazard, and
the pre-decoding stage is a stage of determining whether to multiple-issue the plurality of fetched instructions, based on the stall history information of the buffer.

12. The method of claim 11, wherein
the stall history information comprises tag information of the plurality of stalled multiple-issued instructions and identification information of an instruction causing the stall.

13. The method of claim 12, wherein
the tag information comprises a program counter (PC) value of a first instruction, among the plurality of stalled multiple-issued instructions, and
the identification information comprises information on which instruction, among the plurality of stalled multiple-issued instructions, causes the stall.

14. The method of claim 13, wherein
the tag information is stored in the buffer using a portion of the PC value of the first instruction, among the plurality of stalled multiple-issued instructions,
the identification information is matched with the tag information and stored in the buffer, and
the pre-decoding stage is a stage in which a determination is made as to whether to multiple-issue the plurality of fetched instructions, based on whether the tag information read from a position of the buffer corresponding to the PC value of a first instruction, among the plurality of fetched instructions, matches the PC value of the first instruction, among the plurality of fetched instructions.

15. The method of claim 14, wherein
the pre-decoding stage comprises:
a stage of determining whether to multiple-issue the plurality of fetched instructions, based on whether there is a dependency between the plurality of fetched instructions, when the read tag information does not match the PC value of the first instruction, among the plurality of fetched instructions; and
a stage of determining whether to multiple-issue the plurality of fetched instructions, based on the identification information, when the read tag information matches the PC value of the first instruction, among the plurality of fetched instructions.

16. The method of claim 15, wherein
the pre-decoding stage comprises:
a stage of single-issuing the first instruction, among the plurality of fetched instructions, when the stall is not identified to be caused by the first instruction, among the plurality of stalled multiple-issued instructions, based on the identification information.

17. The method of claim 15, wherein
the processor is an in-order processor using a dual-issue scheme,
the fetching stage is a stage of fetching two instructions together, and
the pre-decoding stage comprises:
a stage of determining whether there is a dependency between the two fetched instructions when the stall is caused by the first instruction, among the plurality of stalled multiple-issued instructions, based on the identification information; and
a stage of single-issuing a second instruction of the fetched two instructions when a result of the determining is that there is no dependency between the two fetched instructions.

18. The method of claim 17, wherein
the stage of determining whether there is a dependency between the two fetched instruction comprises:
a stage of determining whether there is the dependency in a case in which the first instruction of the two instructions is executed first; and
a stage of determining whether there is the dependency in a case in which the second instruction of the two instructions is executed first.

19. The method of claim 11, wherein the decoding stage comprises:
a stage of determining whether the stall is caused by the data hazard, based on whether there is a dependency between the plurality of instructions and previous instructions which are executed in the executing stage, when the plurality of instructions are decoded.

20. The method of claim 19, wherein the decoding stage further comprises:
a stage of updating the stall history information of the buffer using a program counter (PC) value of a first instruction of the plurality of instructions and identification information of an instruction causing a stall of the plurality of multiple-issued instructions when the stall is caused by at least one of the plurality of instructions.
